(19) United States
(12) Patent Application Publication
(10) Pub. No.: US 2020/0097936 A1
(43) Pub. Date: Mar. 26, 2020

(54) ANTIMICROBIAL TREATMENT FOR VENDING MACHINES AND GAMBLING GAMING MACHINES

(71) Applicant: Parasol Medical LLC, Buffalo Grove, IL (US)

(72) Inventor: Patrick E. Eddy, Allendale, MI (US)

(73) Assignee: Parasol Medical LLC, Buffalo Grove, IL (US)

(21) Appl. No.: 16/141,453

(22) Filed: Sep. 25, 2018

(51) Int. Cl. G06Q 20/18; A01N 55/00

(52) U.S. Cl. CPC G06Q 20/18; A01N 55/00

(57) ABSTRACT

A vending machine comprising: a payment interface that accepts payment from a user of the vending machine, the payment interface having an exterior surface; an object dispensary that dispenses an object after the user makes payment via the payment interface, the object dispensary having an exterior surface; and an antimicrobial coating applied to the exterior surface of one or more of the payment interface and object dispensary; wherein, the antimicrobial coating includes a silane quaternary ammonium ion or salt thereof. The silane quaternary ammonium ion or salt thereof can be one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. The vending machine can further include a user interface where the user commands which object the vending machine will dispense at the object dispensary, the user interface having the antimicrobial coating applied to an exterior surface of the user interface.

### BACKGROUND OF THE DISCLOSURE

Vending machines and gambling gaming machines include portions that many users sequentially touch, such as a payment interface, a user interface, and an object dispensary. Each of those portions includes exterior surfaces. The exterior surfaces may contain harmful bacteria, microbes, viruses, and the like, which can be transferred to a multitude of users, spreading diseases. There is a need to modify the exterior surfaces of such high traffic machines like vending machines and gambling gaming machines to prevent the exterior surfaces from harboring bacteria, microbes, viruses, and the like, to prevent such spreading of disease.

### BRIEF SUMMARY OF THE DISCLOSURE

According to a first aspect of the present disclosure, a vending machine comprises: a payment interface that accepts payment from a user of the vending machine, the payment interface having an exterior surface; an object dispensary that dispenses an object after the user makes payment via the payment interface, the object dispensary having an exterior surface; and an antimicrobial coating applied to the exterior surface of one or more of the payment interface and object dispensary; wherein, the antimicrobial coating includes a silane quaternary ammonium ion or salt thereof.

Embodiments of the first aspect of the disclosure can include any one or a combination of the following features:
the vending machine is a change machine, the payment interface accepts payment from the user in the form of paper currency, and the object dispensary dispenses one or more of coin currency or paper currency;
a user interface where the user commands via physical contact with the user interface which object the vending machine will dispense at the object dispensary, the user interface having an exterior surface and the antimicrobial coating is further applied to the exterior surface of the user interface;
the vending machine is a cigarette machine, and the object dispensary dispenses cigarettes;
the vending machine is a food vending machine, and the object dispensary dispenses food;
the vending machine is a bulk vending machine, and the object dispensary dispenses a bulk quantity of objects, and the antimicrobial coating is applied to both the exterior surface of the payment interface and the object dispensary;
the bulk quantity of objects is food;
the vending machine is a newspaper vending machine, and the object dispensary dispenses a newspaper;
the vending machine is a ticket machine, and the object dispensary dispenses one or more tickets; and
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

According to a second aspect of the present disclosure, a gambling gaming machine comprises: a payment interface that accepts payment from a user of the gambling gaming machine, the payment interface having an exterior surface; a user interface where the user plays a game of the gambling gaming machine, the user interface having an exterior surface; and an antimicrobial coating applied to the exterior surface of one or more of the payment interface and user interface; wherein, the antimicrobial coating includes a silane quaternary ammonium ion or salt thereof.

Embodiments of the second aspect of the disclosure can include any one or a combination of the following features:
a coin hopper having an exterior surface, and the antimicrobial coating applied to the exterior surface of the coin hopper;
the user interface includes a lever to be pulled by a user, and the antimicrobial coating is applied to at least the exterior surface of the lever;
the user interface is one or more buttons to be pushed by a user, and the antimicrobial coating is applied to at least the exterior surface of the one or more buttons;
the user interface is a touch screen display to be touched by a user, the touch screen display having an exterior surface, and the antimicrobial coating is applied to at least the exterior surface of the touch screen display; and
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

According to a third aspect of the present disclosure, a method of imparting antimicrobial properties onto an exterior surface of a vending machine comprises: applying, to an exterior surface of a vending machine, a solution including a silane quaternary ammonium ion or salt thereof and isopropyl alcohol; wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride; wherein, the silane quaternary ammonium ion or salt thereof is between 0.1 percent and 10 percent by weight of the solution; and wherein, the isopropyl alcohol is between 30 percent to 90 percent by weight of the solution.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1 is a front view of a vending machine of the present disclosure, illustrating a payment interface, an object dispensary, and a user interface, all having an exterior surface coated with an antimicrobial coating;

FIG. 2 is a perspective view of a change machine embodiment of the vending machine, illustrating the payment interface including a bill feeder disposed in the object dispensary to dispense coins and paper money, the exterior surface of the object dispensary coated with the antimicrobial coating;

FIG. 3 is a perspective view of a cigarette machine embodiment of the vending machine, illustrating the user interface including buttons and the payment interface including a credit card reader and a coin slot;

FIG. 4 is a perspective view of a bulk vending machine embodiment of the vending machine, illustrating food as objects to be vended and dispensed at the object dispensary, the exterior surface of which is coated with the antimicrobial coating;

FIG. 5 is a front view of a newspaper vending machine embodiment of the vending machine, illustrating the object dispensary having a handle and the exterior surface of the object dispensary (including the handle) is coated with the antimicrobial coating;

FIG. 6 is a perspective view of a ticket machine embodiment of the vending machine, illustrating the user interface including a touch screen display, and the exterior surface of the user interface (including the touch screen display) is coated with the antimicrobial coating;

FIG. 7 is a gambling gaming machine of the present disclosure, illustrating the user interface and the payment interface, each having their respective exterior surface coated with the antimicrobial coating;

FIG. 8 is a front view of another embodiment of a gambling gaming machine, illustrating a coin hopper and a lever, each having an exterior surface coated with the antimicrobial coating; and

FIG. 9 is a perspective view of another embodiment of a gambling gaming machine, illustrating the user interface including the touch screen display, and the exterior surface of the user interface including the touch screen display is coated with the antimicrobial coating.

### DETAILED DESCRIPTION

For purposes of description herein, it is to be understood that the specific devices and processes illustrated in the attached drawings, and described in the following specification are simply exemplary embodiments of the inventive concepts defined in the appended claims. Hence, physical characteristics relating to the embodiments disclosed herein are not to be considered as limiting, unless the claims expressly state otherwise.

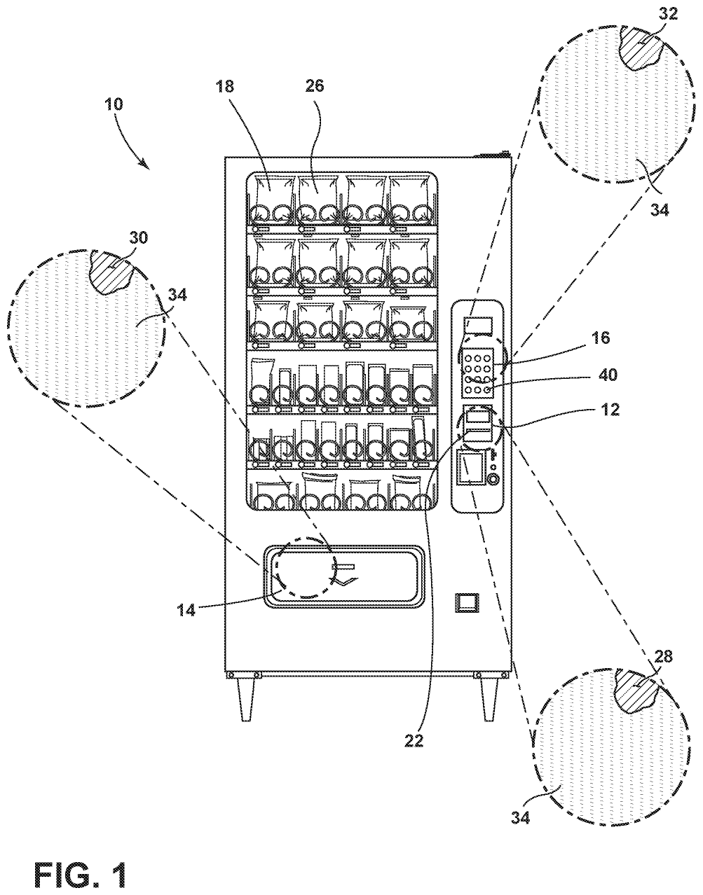

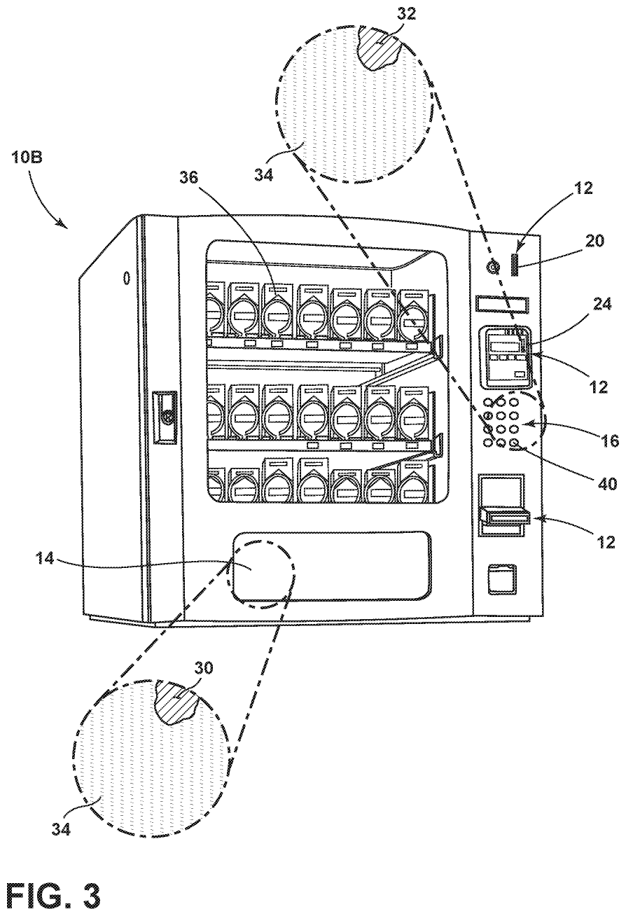

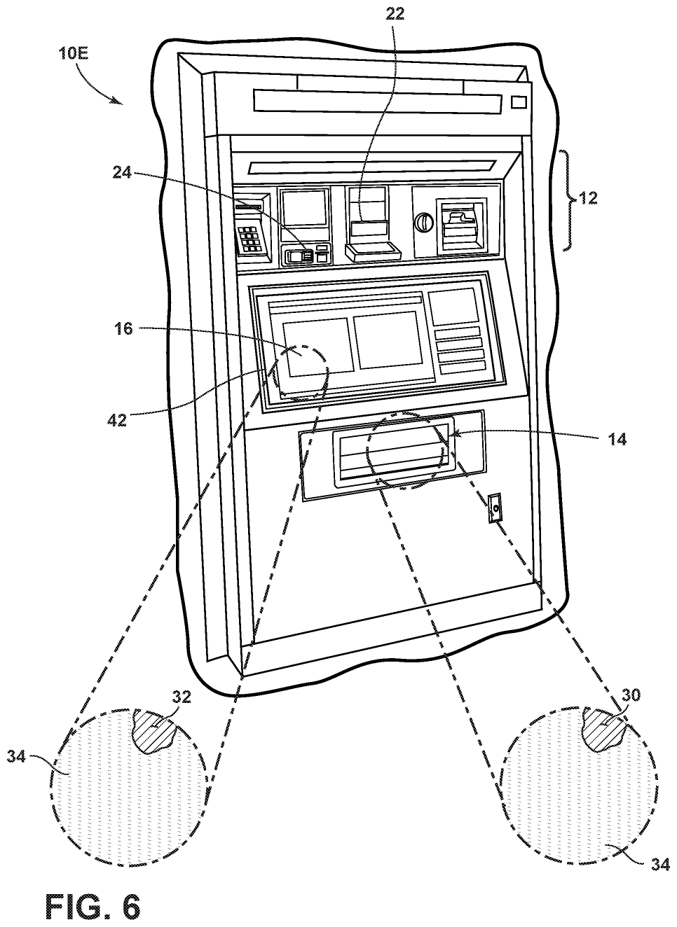

Referring to FIG. 1, a vending machine 10 of the present disclosure is illustrated. The vending machine 10 includes a payment interface 12, an object dispensary 14, and a user interface 16. The payment interface 12 accepts payment from a user (not illustrated) of the vending machine 10. The object dispensary 14 dispenses an object 18 that the user desires to purchase after the user makes payment for the object 18 via the payment interface 12. The user interface 16, if included, is the portion of the vending machine 10 where the user commands, via physical contact with the user interface 16, which object 18 the vending machine 10 will dispense at the object dispensary 14. The payment interface 12 can be a slot 20 that accepts coins (see FIG. 3), a bill feeder 22 that accepts paper money, a credit card reader 24 (see FIG. 3), among other options. The user interface 16 can be buttons 40, a touch screen display 42 (see FIG. 6), among other things. The object dispensary 14 can be any dispensing portion of the vending machine 10 where the user obtains the object 18 purchased from the vending machine 10. In this illustrated embodiment, the vending machine 10 is a food vending machine 10, and thus the object dispensary 14 dispenses food 26. The payment interface 12 has an exterior surface 28. The object dispensary 14 has an exterior surface 30. The user interface 16 has an exterior surface 32. An antimicrobial coating 34 is applied to the exterior surface(s) 28, 30, 32 of one or more of the payment interface 12, the object dispensary 14, and the user interface 16, respectively. In the illustrated embodiment, the antimicrobial coating 34 is applied to the exteriors surfaces 28, 30, 32 of each of the payment interface 12, the object dispensary 14, and the user interface 16. However, in some embodiments where the user is less likely to touch the payment interface 12, for example, the antimicrobial coating 34 may only be applied to the exterior surfaces 30, 32 of the object dispensary 14 and the user interface 16 (if included), respectively. The antimicrobial coating 34 can be applied to the vending machine 10 generally.

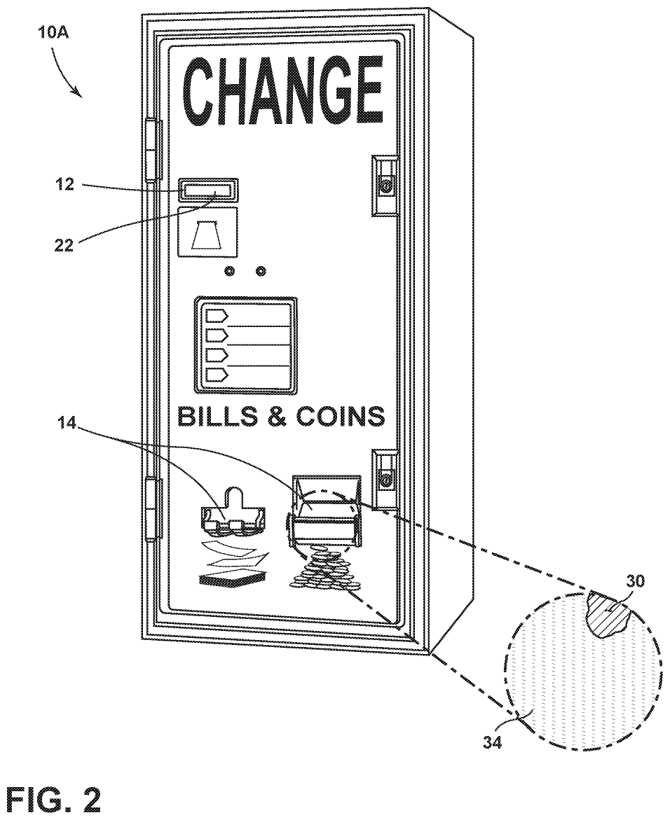

Referring now to FIG. 2, another embodiment of a vending machine 10, a change machine 10A, is illustrated. In the embodiment of the change machine 10A, the payment interface 12 accepts payment from the user, typically in the form of paper currency inserted into the bill feeder 22. In return, the object dispensary 14 dispenses one or more of coin currency or paper currency, typically of a smaller denomination than the denomination of the paper currency inserted into the change machine 10A by the user. It may be particularly advantageous to apply the antimicrobial coating 34 to the exterior surface 30 of the object dispensary 14 of the change machine 10A. The antimicrobial coating 34 can be applied to the change machine 10A generally.

Referring now to FIG. 3, another embodiment of a vending machine 10, a cigarette machine 10B, is illustrated. The objects 18 that the cigarette machine 10B vends are cigarettes 36. The cigarette machine 10B accepts payment from the user at the payment interface 12. At the user interface 16, the user commands which cigarettes 36 the cigarette machine 10B will dispense at the object dispensary 14. It may be particularly advantageous to apply the antimicrobial coating 34 to the exterior surfaces 30, 32 of the object dispensary 14 and the user interface 16, respectively, of the cigarette machine 10B. The antimicrobial coating 34 could be applied to the exterior surface 28 of the payment interface 12, or the cigarette machine 10B generally.

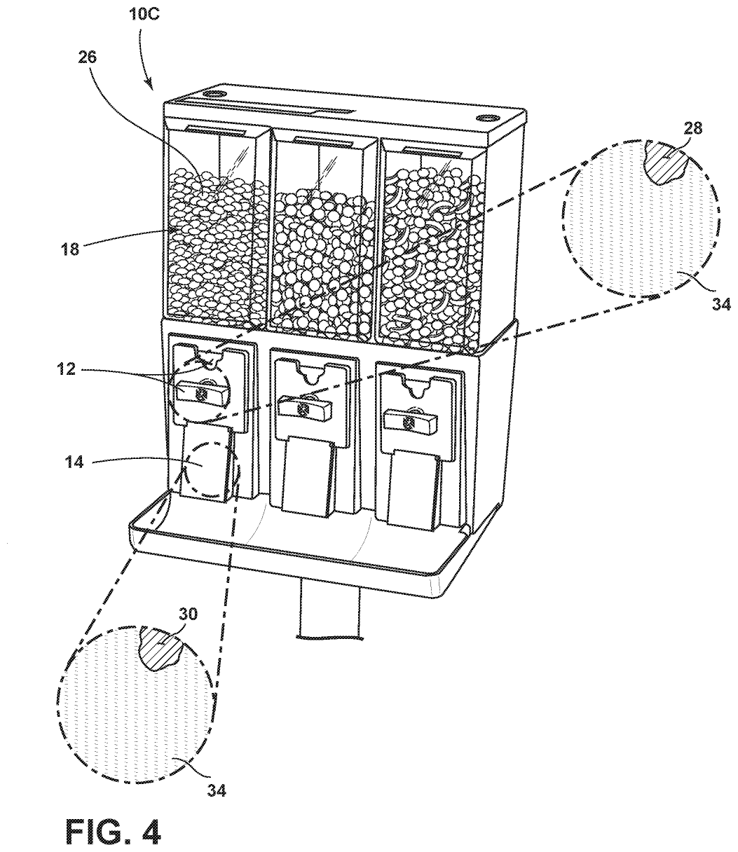

Referring now to FIG. 4, another embodiment of a vending machine 10, a bulk vending machine 10C, is illustrated. The bulk vending machine 10C accepts payment, which is often in the form of coin currency, from the user at the payment interface 14. The bulk vending machine 10C dispenses a bulk quantity of objects 18 at the object dispensary 14. The objects 18 dispensed can be food 26, such as candy or gum, or small non-food items such as toys. It may be particularly advantageous to apply the antimicrobial coating 34 to the exterior surfaces 28, 30 of the payment interface 14 and the object dispensary 14, respectively. The antimicrobial coating 34 could be applied to the bulk vending machine 10C generally.

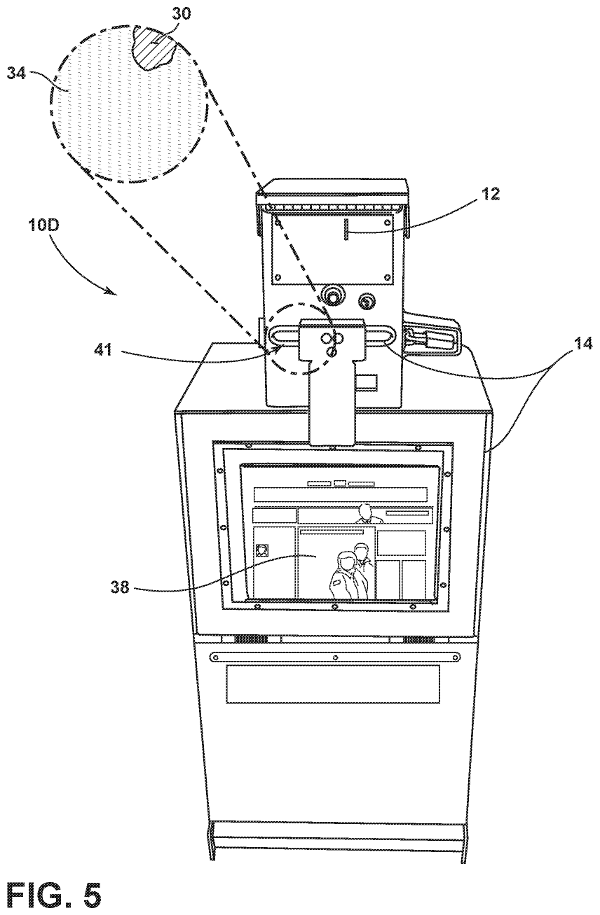

Referring now to FIG. 5, another embodiment of a vending machine, a newspaper vending machine 10D, is illustrated. The newspaper vending machine 10D accepts payment, which is often in the form of coin currency, from the user at the payment interface 12. The objects 18 that the newspaper vending machine 10D dispenses are newspapers 38 at the object dispensary 14, which in this particular embodiment includes a handle 41. It may be particularly advantageous to apply the antimicrobial coating 34 to the exterior surface 30 of the object dispensary 14, including the handle 41 thereof. The antimicrobial coating 34 could also be applied to the exterior surface 28 of the payment interface 14, or the newspaper vending machine 10D generally.

Referring now to FIG. 6, another embodiment of a vending machine 10, a ticket machine 10E, is illustrated. The ticket machine 10E accepts payment from the user at the payment interface 14. The user commands the ticket machine 10E to dispense the object 18, i.e., one or more tickets, at the user interface 16, which in this instance is the touch screen display 42. The ticket machine 10E dispenses one or more tickets at the object dispensary 14. It may be particularly advantageous to apply the antimicrobial coating 34 to the exterior surfaces 32, 30 of the user interface 16 and object dispensary 14, respectively. The antimicrobial coating 34 could also be applied to the payment interface 12, or the ticket machine 10E generally.

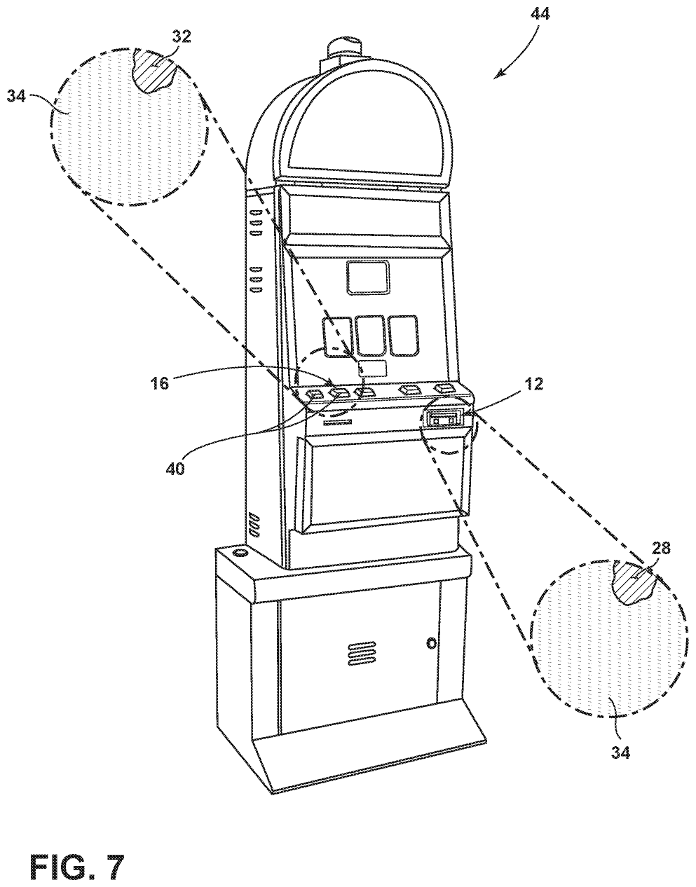

Referring now to FIG. 7, a gambling gaming machine 44 is illustrated. The gambling gaming machine 44, like the vending machines 10-10E, includes the payment interface 12 and the user interface 16. At the payment interface 12, the gambling gaming machine 44 accepts payment from the user (e.g., money, a ticket, a casino gaming card, etc.). At the user interface 16, the user plays a game of the gambling gaming machine 44. The user interface 16 in the illustrated embodiment includes one or more buttons 40 to be pushed by the user. Each of the payment interface 12 and the user interface 16 have their respective exterior surface 28, 32. The antimicrobial coating 34 is applied to the exterior surface 32, 28, respectively of either the user interface 16 or the payment interface 12 or both. In the illustrated embodiment, because the user interface 16 includes buttons 40, applying the antimicrobial coating 34 to the exterior surface 32 of the user interface 16 includes applying the antimicrobial coating 34 to the exterior surface 32 at the buttons 40.

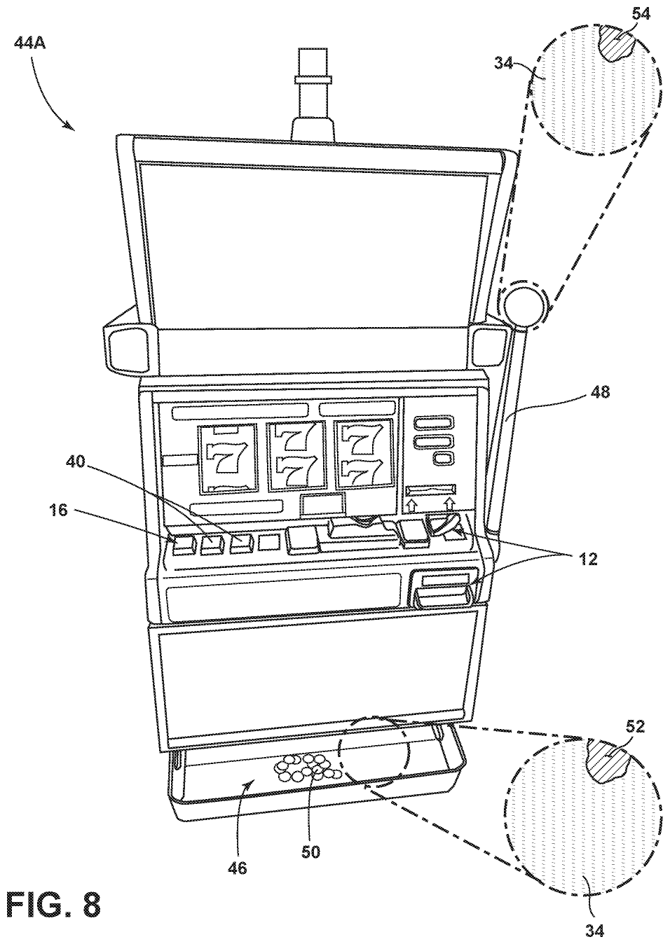

Referring now to FIG. 8, an alternative embodiment gambling gaming machine 44A is illustrated. The gambling gaming machine 44A further includes a coin hopper 46 and a lever 48, which is part of the user interface 16. The user can pull the lever 48 rather than press the buttons 40 to activate the game of the gambling gaming machine 44A. The gambling gaming machine 44A distributes coins 50 to the user if the user wins a game. The coin hopper 46 and the lever 48 each have an exterior surface 52, 54, respectively. It may be particularly advantageous to apply the antimicrobial coating 34 to the exterior surfaces 52, 54 of the coin hopper 46 and the lever 48. The antimicrobial coating 34 can be applied to the payment interface 12, the rest of the user interface 16, and the gambling gaming machine 44A generally.

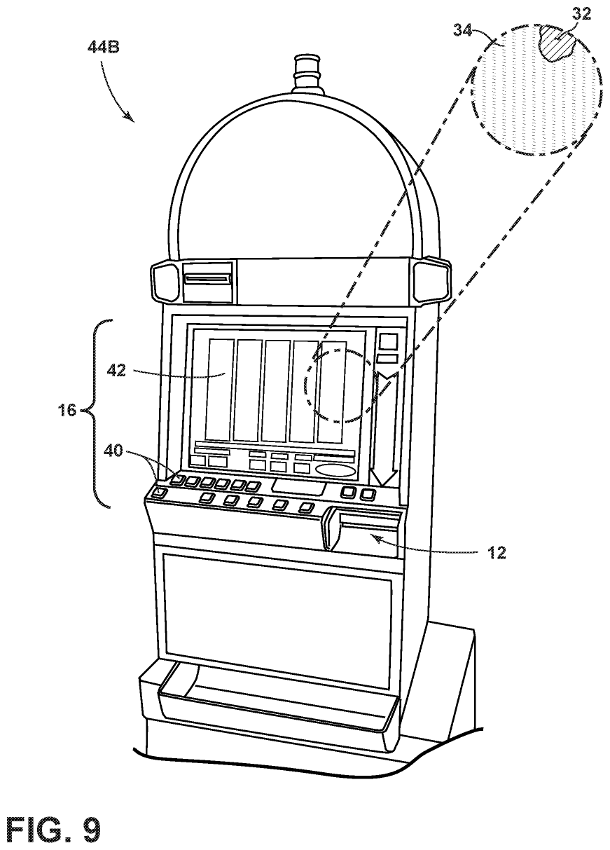

Referring now to FIG. 9, an alternative embodiment gambling gaming machine 44B is illustrated. The gambling gaming machine 44B further includes the touch screen display 42 as part of the user interface 16. The user touches the touch screen display 42 as part of the game of the gambling gaming machine 44B. The antimicrobial coating 34 it may be particularly advantageously applied to the exterior surface 32 of the user interface 16, which here includes the touch screen display 42.

The antimicrobial coating 34 includes a silane quaternary ammonium ion or salt thereof. Preferred silane quaternary ammonium ions or salts thereof include 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. Applying the antimicrobial coating 34 to the various exterior surfaces 28, 30, 32, 52, 54 imparts antimicrobial properties on the various exterior surfaces 28, 30, 32, 52, 54, which prevent or lessen the ability of said exterior surfaces 28, 30, 32, 52, 54 to harbor harmful microbes, viruses, bacteria, and the like and spread them to user after user.

Further described herein is a novel method of imparting antimicrobial properties onto any or all of the exterior surfaces 28, 30, 32, 52, 54 of the vending machines 10, 10A-10E or gambling gaming machines 44, 44A, 44B described above, and onto the exterior surfaces of the vending machines 10, 10A-10E or gambling gaming machines 44, 44A, 44B generally. The method comprises applying, to any of the exterior surfaces 28, 30, 32, 52, 54 of the vending machines 10, 10A-10E or gambling gaming machines 44, 44A, 44B, a solution including the silane quaternary ammonium ion or salt thereof, as described above. In addition to the silane quaternary ammonium ion or salt thereof, the solution can further include a solvent. A preferred solvent is isopropyl alcohol.

The silane quaternary ammonium ion or salt thereof can comprise between 0.1 percent and 10 percent by weight of the solution. More preferably, the silane quaternary ammonium ion or salt thereof can comprise between 0.75 percent and 5 percent by weight of the solution. Even more preferably, the silane quaternary ammonium ion or salt thereof can comprise between 1.9 percent and 2.1 percent by weight of the solution.

As for the isopropyl alcohol, the isopropyl alcohol can comprise between 30 percent to 90 percent by weight of the solution. More preferably, the isopropyl alcohol can comprise between 55 percent and 65 percent by weight of the solution. An example preferable solution comprises (by weight) 60.0 percent isopropyl alcohol, 2.02 percent 3-(trimethoxysilyl)propyldimethyloctadecyl ammonium chloride, and 34.19 percent deionized water.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vending machine comprising:
a payment interface that accepts payment from a user of the vending machine, the payment interface having an exterior surface;
an object dispensary that dispenses an object after the user makes payment via the payment interface, the object dispensary having an exterior surface; and
an antimicrobial coating applied to the exterior surface of one or more of the payment interface and object dispensary;
wherein, the antimicrobial coating includes a silane quaternary ammonium ion or salt thereof.

2. The vending machine of claim 1,
wherein, the vending machine is a change machine, the payment interface accepts payment from the user in the form of paper currency, and the object dispensary dispenses one or more of coin currency or paper currency.

3. The vending machine of claim 1 further comprising:
a user interface where the user commands via physical contact with the user interface which object the vending machine will dispense at the object dispensary, the user interface having an exterior surface and the antimicrobial coating is further applied to the exterior surface of the user interface.

4. The vending machine of claim 3,
wherein, the vending machine is a cigarette machine, and the object dispensary dispenses cigarettes.

5. The vending machine of claim 3,
wherein, the vending machine is a food vending machine, and the object dispensary dispenses food.

6. The vending machine of claim 1,
wherein, the vending machine is a bulk vending machine, and the object dispensary dispenses a bulk quantity of objects, and the antimicrobial coating is applied to both the exterior surface of the payment interface and the object dispensary.

7. The vending machine of claim 6, wherein the object is food.

8. The vending machine of claim 1,
wherein, the vending machine is a newspaper vending machine, and the object dispensary dispenses a newspaper.

9. The vending machine of claim 3,
wherein, the vending machine is a ticket machine, and the object dispensary dispenses one or more tickets.

10. The vending machine of any one of claim 1, 3, or 5, wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

11. A gambling gaming machine comprising:
a payment interface that accepts payment from a user of the gambling gaming machine, the payment interface having an exterior surface;
a user interface where the user plays a game of the gambling gaming machine, the user interface having an exterior surface; and
an antimicrobial coating applied to the exterior surface of one or more of the payment interface and user interface;
wherein, the antimicrobial coating includes a silane quaternary ammonium ion or salt thereof.

12. The gambling gaming machine of claim 11 further comprising:
a coin hopper having an exterior surface, and the antimicrobial coating applied to the exterior surface of the coin hopper.

13. The gambling gaming machine of claim 11,
wherein, the user interface includes a lever to be pulled by a user; and
the antimicrobial coating is applied to at least the exterior surface of the lever.

14. The gambling gaming machine of claim 11,
wherein, the user interface is one or more buttons to be pushed by a user; and
the antimicrobial coating is applied to at least the exterior surface of the one or more buttons.

15. The gambling gaming machine of claim 11,
wherein, the user interface is a touch screen display to be touched by a user, the touch screen display having an exterior surface; and
the antimicrobial coating is applied to at least the exterior surface of the touch screen display.

16. The gambling gaming machine of any one of claims 11-12,
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

17. A method of imparting antimicrobial properties onto an exterior surface of a vending machine comprising:
applying, to an exterior surface of a vending machine, a solution including a silane quaternary ammonium ion or salt thereof and isopropyl alcohol;
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride;
wherein, the silane quaternary ammonium ion or salt thereof is between 0.1 percent and 10 percent by weight of the solution; and
wherein, the isopropyl alcohol is between 30 percent to 90 percent by weight of the solution.
